(19) United States
(12) Patent Application Publication
(10) Pub. No.: US 2026/0203808 A1
(43) Pub. Date: Jul. 16, 2026

(54) Blockchain-based secondary creative management system and method

(71) Applicant: Ki-won NAM, Seoul (KR)

(72) Inventor: Ki-won NAM, Seoul (KR)

(21) Appl. No.: 18/728,799

(22) PCT Filed: Jan. 10, 2023
(86) PCT No.: PCT/KR2023/000449

§ 371 Date: Jul. 12, 2024

(30) Foreign Application Priority Data
Jan. 12, 2022 (KR) 10-2022-0004373
Jan. 6, 2023 (KR) 10-2023-0002004

(51) Int. Cl. G06Q 30/08; G06Q 20/12; G06Q 20/36

(52) U.S. Cl. CPC G06Q 30/08; G06Q 20/123; G06Q 20/36; G06Q 2220/00

(57) ABSTRACT

The present invention relates to a blockchain-based secondary creative work management system and a method therefor, and an object thereof is to provide a blockchain-based secondary creative work management system and a method therefor which enable users to perform new communicative creation through the processes of: dividing a display space of a primary creative work uploaded by a primary creator into a plurality of cells; and issuing and distributing, as a blockchain-based NFT, information on the primary creative work and location information of the cells on the primary creative work, which allows secondary creative works to be displayed in each cell on the primary creative work.

### TECHNICAL FIELD

The present invention relates to a blockchain-based secondary creative work management system and a method therefor, and more specifically, to a blockchain-based secondary creative work management system and a method therefor which enable users to perform new communicative creation through the processes of: dividing a display space of a primary creative work uploaded by a primary creator into a plurality of cells; and issuing and distributing, as a blockchain-based NFT, information on the primary creative work and location information of the cells on the primary creative work, which allows secondary creative works to be displayed in each cell on the primary creative work.

### BACKGROUND ART

As well known in the art, creative works based on copyright representatively include literary works including novels and poems, artistic works including pure and applied arts, and musical works in which music is record in various types of recording media and distributed so as to be played. In addition thereto, there are various types of creative works.

Pricing of works of art is measured differently depending on the auctioneer, gallery, or consultant who relays each transaction. As a typical price measurement method, there is a method for calculating a price of a work of art by referring to the estimated price thereof and the transaction price of works similar thereto. In general, the more transaction records available for reference, the more transparent transactions become possible.

At this time, the transaction records available for reference include data provided for a fee by international companies such as ARTNET, ARTSY and ARTPRICE, etc. However, since the transaction records provided by the companies are also provided in a spreadsheet such as an Excel file, the accuracy of the data cannot be trusted. Since all the data provided by the data providers are owned themselves and the works of art are sold at high prices, it is difficult for ordinary purchasers to check the transaction record data for the works of art that they want to purchase.

In addition, the safety of data on transaction records and ownership for the works of art cannot be secured, and there is a risk that security problems may be exposed when trading the works of art.

Accordingly, Korean Patent Laid-Open Publication No. 10-2016-0000021 (hereinafter referred to as Patent Document 1) discloses a system for price search of artwork and art market statistical analysis, which analyzes information on the prices and trends of artworks using an analysis software and provides the information to customers, rather than directly writing the prices of artwork and art market statistical analysis by a manager, such that reliability may be increased and manual updates may be minimized, thus to easily manage the related data.

However, in the above-described Patent Document 1, when request information regarding the price of the artwork or art market statistical analysis is received from a customer terminal, artwork information is collected from an artwork auction server based on the request information, and analyzed using a big data analysis technique, and then artwork price information and art market statistical analysis information are generated to transmit them to the customer terminal. In this case, since the customer should directly provide information on the desired artwork, only the artwork information corresponding to the requested information can be checked. Therefore, information on various artworks cannot be easily checked, and the generated price information is also provided without performing a verification process, such that reliability is low.

In addition, Korean Patent Registration No. 10-1867343 (hereinafter referred to as Patent Document 2) discloses an online artwork trading platform and operation method using an online gallery, in which potential purchasers may find various artists or collectors and their artworks through the online gallery, and a user who purchases an artwork may resell the artwork immediately after purchase using the online gallery without any extra effort. As a result, continuous re-trading of a single artwork may be activated.

However, according to the above-described Patent Document 2, the artwork owned by the user can be used for data analysis only when it is provided to the online gallery. In other words, since ownership of the data on the provided artwork is not granted to the user, profits generated when providing information on the artwork cannot be distributed.

Meanwhile, objects based on copyrights may have an asset-based value, thus to be traded with other users. Therefore, in the process of trading the object, a method capable of transferring the object after checking clear ownership thereof is required.

Recently, to this end, techniques or methods capable of verifying or trading ownership information on the object using blockchain-based non-fungible tokens (NFTs) have been proposed.

Meanwhile, a means for a person accessing such the object to check the NFT issued for the object is required. For example, if there is a need to provide a pre-issued blockchain-based NFT for a specific object to people accessing the object, the object should be clearly identified and information on the blockchain-based NFT for the object should be provided to the people. In this regard, a technique of generating a unique code for an object and requesting and verifying the provision of information on the NFT based on the code is known in the art.

Through this technique, for objects that are offline creative works, there are cases where the objects are converted into blockchain-based NFT information as they are and used as virtual works. However, it can be seen that the above-described case may infringe the copyright of an original creator. Therefore, various disputes are currently occurring.

In addition, there is a case where secondary creative works that parody offline creative works are converted into blockchain-based NFT information and implemented as virtual works. However, in this case as well, it may become an excuse for a copyright dispute to arise with the original creator. In this case, the following problems may generally occur.

First, when the scope of the original creator's copyright is determined to be too broad, the will of creation for virtual secondary creative works may be discouraged, such that an environment in which excellent works can be produced may not be achieved.

Second, when the scope of the original creator's copyright is determined too narrow, the virtual secondary creative works may be overused and the purpose of the original copyrighted work may be damaged. In particular, the original copyright holder may not receive profits from NFT coins, which are virtual secondary creative works. Up to now, there is no system in which the original copyright holder divides some of the creative rights to virtual secondary creators, and the profits resulting from the division are distributed.

Third, following the second problem above, when the original creative work is image rights of a star and a plurality of fans work together with the star on a virtual secondary creative work, there is no system in which the profits from NFT coins based on the image rights of the star can be rationally distributed between the star and the plurality of fans, and some creators can transfer the divided ownership to a third party by reflecting the current price of the NFT coin in relation thereto. Therefore, even in recent years when various cultural products about virtual worlds such as the Metaverse, etc. have been released, creative work products are still not actively produced.

### SUMMARY OF INVENTION

### Problems to Be Solved by Invention

In consideration of the above-described circumstances, it is an object of the present invention to provide a blockchain-based secondary creative work management system and a method therefor which enable users to perform new communicative creation through the processes of: dividing a display space of a primary creative work uploaded by a primary creator into a plurality of cells; and issuing and distributing, as a blockchain-based NFT, information on the primary creative work and location information of the cells on the primary creative work, which allows secondary creative works to be displayed in each cell on the primary creative work.

### Means for Solving Problems

To achieve the above object, according to an aspect of the present invention, there is provided a blockchain-based secondary creative work management system, the system including a cell NFT management server 10 which includes: a primary creative work registration unit 16 configured to register a primary creative work permitted by an original creator to display a secondary creative work of a secondary creator at a specific location on the primary creative work; a cell division unit 24 configured to divide a display space on the primary creative work into a plurality of cells so that a plurality of secondary creative works are displayed on the primary creative work registered in the primary creative work registration unit 16; a secondary creative work registration unit 18 configured to map the secondary creative works of the secondary creator with locations of each cell of the primary creative work divided through the cell division unit 24 and register them, wherein the secondary creator has bought rights to display the secondary creative works at the locations; and a token issuance request unit 34 configured to request a generation of a non-fungible token (NFT) consisting of data related to the primary creative work and the cells, and an electronic wallet address on the blockchain using a smart contract.

Preferably, the cell NFT management server 10 further includes: a primary creative work storage unit 36 configured to store an original file (1_O_F) of the primary creative work permitted by an original creator to display the secondary creative work of the secondary creator at a specific location on the primary creative work; and a secondary creative work storage unit 38 configured to map an original file (2_O_F) of the secondary creative work registered through the secondary creative work registration unit 18 with a location of a cell divided and transferred by the secondary creator and store the same.

Preferably, information recorded in blocks through the smart contract comprises at least an address code indicating a storage path of the primary creative work, address codes corresponding to the locations occupied by each cell in the primary creative work, and transaction history information.

Preferably, the cell NFT management server 10 further includes an object unique information acquisition unit 28 configured to automatically acquire and manage unique information on the object of the creative work to be registered by the original creator in the primary creative work registration unit 16, wherein the object unique information is included in information recorded in the blocks through the smart contract.

Preferably, the cell NFT management server 10 further includes a linkage meta information address management unit 32 configured to: receive a registration request signal for meta information in conjunction with the secondary creative work from a buyer terminal; register the linkage meta information; and manage the address.

Preferably, the cell NFT management server 10 further includes: a secondary creative work posting condition setting unit 26 configured to set a posting condition guide of the secondary creative works for the primary creative work permitted by the primary creator to the secondary creator; and a secondary creative work condition coincidence determination unit 30 configured to automatically determine whether the creative work of the secondary creator coincides with information on the posting condition guide.

Preferably, the cell NFT management server 10 further includes a cell location code management unit 22 configured to manage location information of the cells included for each non-fungible token (NFT).

Preferably, the cell NFT management server 10 further includes a creative work storage path management unit 20 configured to manage storage path information of the primary creative work and secondary creative work.

Preferably, the system further includes an NFT transaction processing server 8 which includes: a cell transaction processing unit 44 which processes to trade the cells divided into the plurality of cells so that each of the plurality of secondary creative works is displayed on the primary creative work, in conjunction with the cell NFT management server 10; a cell transfer amount division calculation unit 46 configured to calculate and distribute a transfer amount generated through a transaction of any one cell between the primary creator of the primary creative work to which the cell belongs and owners of other cells excluding the owner of the cell that belongs to the primary creative work and the transaction has been made as a benefit amount; a cell transaction smart contract information generation unit 48 configured to generate a code to record ownership change information changed due to a transfer of the cell as a code to be recorded in the blockchain; and a cell transaction smart contract information management unit 50 configured to manage information generated through the cell transaction smart contract information generation unit 48.

Preferably, the NFT transaction processing server 8 further includes: a secondary creative work posting condition management unit configured to register and manage creator's posting conditions for the secondary creative works; and a BIX token payment processing unit 52 configured to perform payment processing of a Blue IndeX (BIX) token, such as payment for verification of the primary creative work and verification of cell's ownership information, or payment for takeover of the cells.

Preferably, the primary creative work is visible image data including a pictorial of a star, an image of star's daily life, a movie poster or movie scene data, or broadcast scene data or painting work, or acoustic data displayed as a digital waveform such that each section can be divided.

Preferably, the cells are distinguished by dividing a size of a single primary creative work into a grid frame having a predetermined number of rows and columns.

Preferably, the cell transaction processing unit 44 processes to: register a minimum bid amount in consideration of an amount of the creative work set by the primary creator; register the number of cells to be divided and transferred and a minimum bid amount per unit thereof to perform bid reception from users; and perform successful bid processing for each cell in an order of the highest bid amount.

Preferably, the cell transfer amount division calculation unit 46 processes to calculate so that a calculation ratio for an original creator, which is preset for a transfer amount of any one cell, and a calculation ratio for owners who own other cells excluding a transferor who transfers the cell, are proportional to an initial bid amount.

According to another aspect of the present invention, there is provided a blockchain-based secondary creative work management method, which includes: a) receiving, by a cell NFT management server 10, token issuance request information including original data of a primary creative work and the number of cells generated by dividing the original data from a creator terminal 2 of a primary creator; b) dividing, by the cell NFT management server 10, the registered primary creative work into a plurality of cells; c) performing, by an NFT transaction processing server 8, auction processing on the plurality of divided cells; d) receiving and registering, by the cell NFT management server 10, a creative work of a secondary creator in the divided cell; e) processing, by the NFT transaction processing server 8, issuing of an NFT including creative work-related information which includes a storage path address of the primary creative work and location addresses of the cells, and processing to record the creative work-related information in blocks based on the blockchain.

Preferably, the step c) includes performing auction processing in a way that minimum bid amounts are different depending on the locations of the cells formed by spatially dividing the primary creative work into a grid frame.

Preferably, in any one of the steps c) and d), when receiving a request to perform blockchain verification for the primary creative work and blockchain verification for the cells, paying a predetermined amount of coins to the blockchain system, by the NFT transaction processing server 8.

Preferably, in the step d), if conditions of the secondary creative work do not coincide with conditions registered by the primary creator, processing so as not to register the secondary creative work in the cell bough by the secondary creator, by the cell NFT management server 10.

Preferably, in the step e), further comprising adding owner information of the cell, object information of the creative work, and transaction history information on the cell to the NFT to be included therein.

Preferably, after the step e), the method further includes performing, by the NFT transaction processing server 8, division payment processing according to a calculation ratio for the primary creator, which is preset for a transfer amount of any one cell, and a calculation ratio for owners who own other cells excluding a transferor who transfers the cell.

Preferably, in the processing step for calculation, the division payment processing according to the calculation ratio for owners who own other cells in the same primary creative work excluding the transferor who transfers the cell further includes performing calculation processing in proportion to an initial bid amount.

Preferably, the step d) further includes receiving, by the cell NFT management server 10, a registration request signal for meta information in conjunction with the secondary creative work from the creator terminal 2 of the secondary creator, and mapping the received registration request signal.

### Advantageous Effects

The blockchain-based secondary creative work management system and method according to the present invention allow fans to display their secondary creative works on an original creative work of a star, thereby, through communication between the star and the fans by means of combination or connection between works with different independent personalities, they can protect each other's individuality, see each other's work, and notify their individuality to more users. Since these communication creative works are issued as blockchain-based NFTs, the permanence of blockchain characteristics may be extended and applied to communicative creation. In addition, in pursuing the economic interests of the fans and star, a communal fate can be shared, and as a result, communication can be maximized.

### BRIEF DESCRIPTION OF DRAWINGS

FIG. 1 is a block diagram illustrating the schematic configuration of a blockchain-based secondary creative work management system according to an embodiment of the present invention;

FIGS. 2A to 2G are images illustrating selection and display status of a primary creative work and secondary creative works which are cell-processed within the primary creative work through the blockchain-based secondary creative work management system according to an embodiment of the present invention;

FIG. 3 is a block diagram illustrating the configuration of a cell NFT management server included in the blockchain-based secondary creative work management system according to an embodiment of the present invention;

FIG. 4 is a block diagram illustrating the configuration of an NFT transaction processing server included in the blockchain-based secondary creative work management system according to an embodiment of the present invention; and

FIG. 5 is a flowchart illustrating procedures related to permission and registration processing for secondary creative works through the blockchain-based secondary creative work management system according to an embodiment of the present invention.

### MODE FOR CARRYING OUT INVENTION

Hereinafter, the present invention will be described in detail with reference to the accompanying drawings.

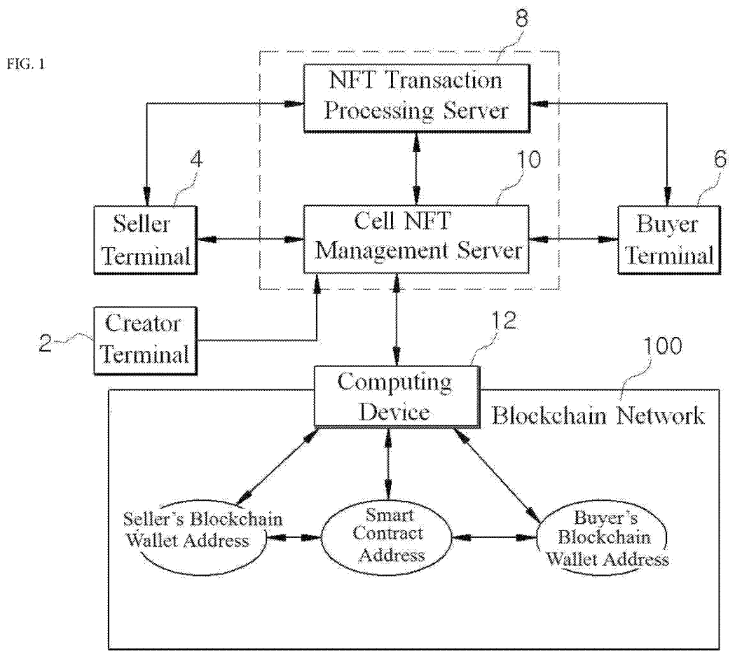

FIG. 1 is a block diagram illustrating the schematic configuration of a blockchain-based secondary creative work management system according to an embodiment of the present invention.

Referring to FIG. 1, the blockchain-based secondary creative work management system according to an embodiment of the present invention is a blockchain-based secondary creative work management system which enables users to perform new communicative creation through the processes of: dividing a display space of a primary creative work uploaded by a primary creator into a plurality of cells; and issuing and distributing, as a blockchain-based NFT, information on the primary creative work and location information of the cells on the primary creative work, which allows secondary creative works to be displayed in each cell on the primary creative work.

An increase in the value of a star's creative work, which may be a primary creative work, means that: the star's primary creative work can be issued as blockchain-based non-fungible tokens (NFTs), thereby making it to have permanency; and in addition thereto, the value may be further increased by forming hash data for location address values of the cells obtained by dividing the star's primary creative work as non-fungible tokens (NFTs), registering secondary creative works by a fan who owns the location address of the cell in conjunction with the location of the cell, and supporting so that the creative works can be red on the platform of the present invention, in particular, by implementing the proof of the communication between the star and the fans as a storage value managed in a way that forgery and falsification thereof are impossible.

In addition, the increase in the value of the star's creative work means an increase in the economic value assigned to the star obtained by issuing the star's creative work as the non-fungible tokens (NFTs).

Further, the increase in the value of the star's creative work means that, when the star's creative work is issued as the non-fungible tokens (NFTs), fans participate as purchasers of the cells included in the star cell NFT implemented through the NFT issuance system of the present invention, such that the investment value of the fans due to an increase in the obtained market value of the NFT is increased.

In more detail, the blockchain-based secondary creative work management system according to an embodiment of the present invention includes a cell NFT management server 10 configured to: register a star's primary creative work; divides the primary creative work into a plurality of grids on an image to generate cells; request an NFT transaction processing server 8 to package data including hash data for location address values of the divided cells and mint them as non-fungible tokens (NFTs); register secondary creative works to be displayed in conjunction with the location by a fan who owns the location addresses of the cells; and support so that the creative works can be red on the platform of the present invention.

Here, the present disclosure will be described by distinguishing a creator terminal 2 for allowing the star as the primary creator, and the fan as the secondary creator, to upload the creative works to the cell NFT management server 10, or register and update metadata such as SNS information of the secondary creator from seller and buyer terminals that generate signals to sell and buy the non-fungible tokens (NFTs).

The cells may be distinguished by dividing the display space of a single primary creative work into a grid frame having a predetermined number of rows and columns.

In addition, the blockchain-based secondary creative work management system according to an embodiment of the present invention includes the NFT transaction processing server 8 configured to generate a smart contract-based NFT through a blockchain network 100 and records it in blocks according to a signal received with a request to package data including hash data for the location address values of the cells and generate non-fungible tokens (NFTs) in conjunction with the cell NFT management server 10. The NFT transaction processing server 8 receives sell and buy-related signals from a seller terminal 4 and a buyer terminal 6, and performs cell NFT transaction processing according to electronic wallet addresses of each subject.

In addition, the NFT transaction processing server 8 records the smart contract in the blocks through the blockchain network 100.

The blockchain network 100 has a known smart contract configuration for relaying transactions through blockchain addresses or storing NFTs in each node.

The NFT transaction processing server 8 included in the system of the present invention may package information related to the creative works, and map the packaging information with a seller's blockchain wallet address, a buyer's blockchain wallet address and a smart contract address, thereby allowing the transaction parties to perform transaction through the NFT transaction processing server 8, but in reality, safely perform transaction on the blockchain network 100.

Accordingly, the NFT transaction processing server 8 may transmit verification request information for the information of a specific NFT requested from the creator terminal 2, the seller terminal 4, or the buyer terminal 6 to the blockchain network 100. If the result acquired from the computing device 12 of the blockchain network 100 is true, the NFT transaction processing server may provide at least one of the NFTs for the objects, information related to the NFTs, and information on the objects to the terminals 2, 4 and 6. On the other hand, if the verification result received from the blockchain network 100 is false, the NFT transaction processing server 8 may not provide the NFTs for the objects, the information related to the NFTs, and the information on the objects to the terminals 2, 4 and 6.

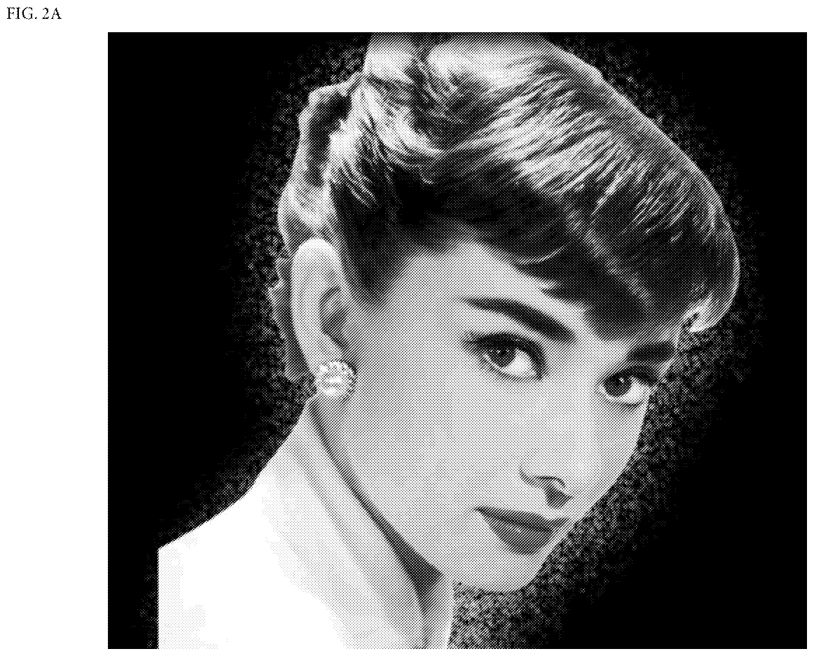

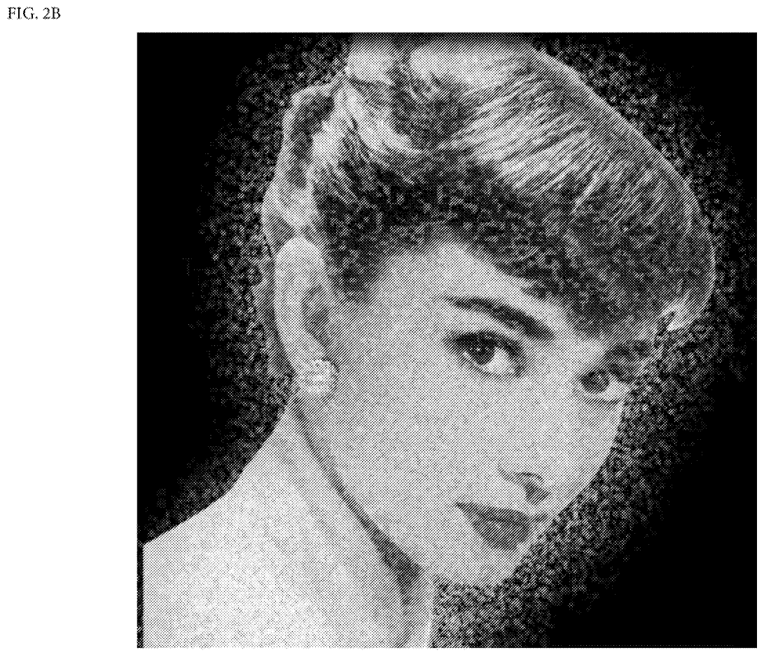

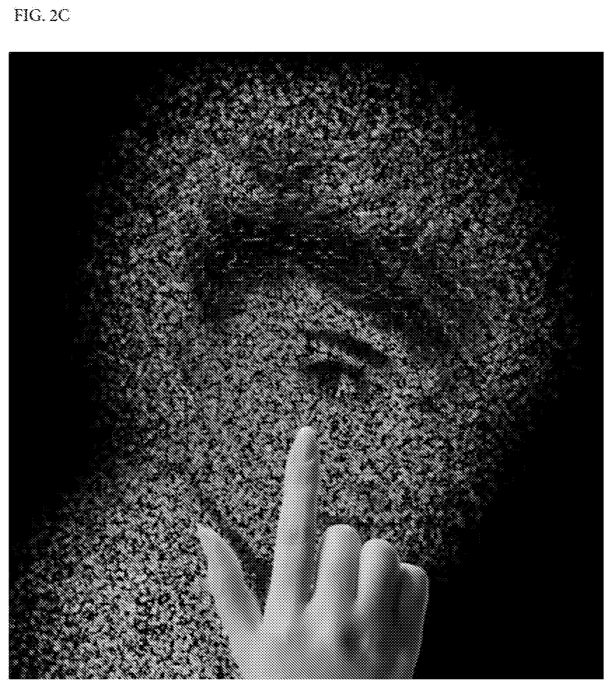

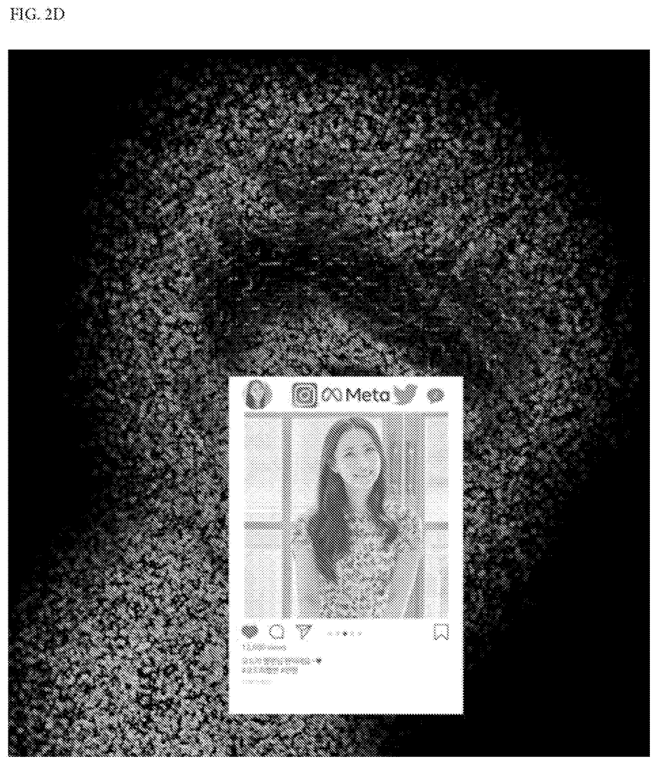

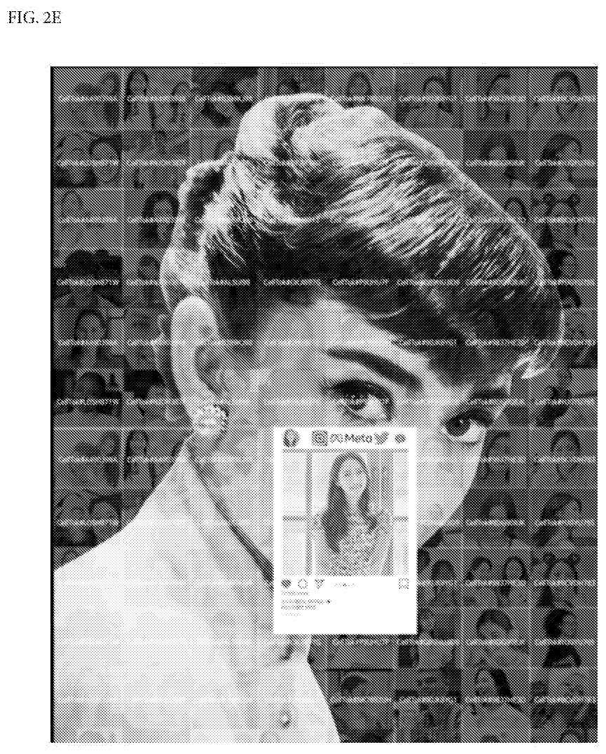

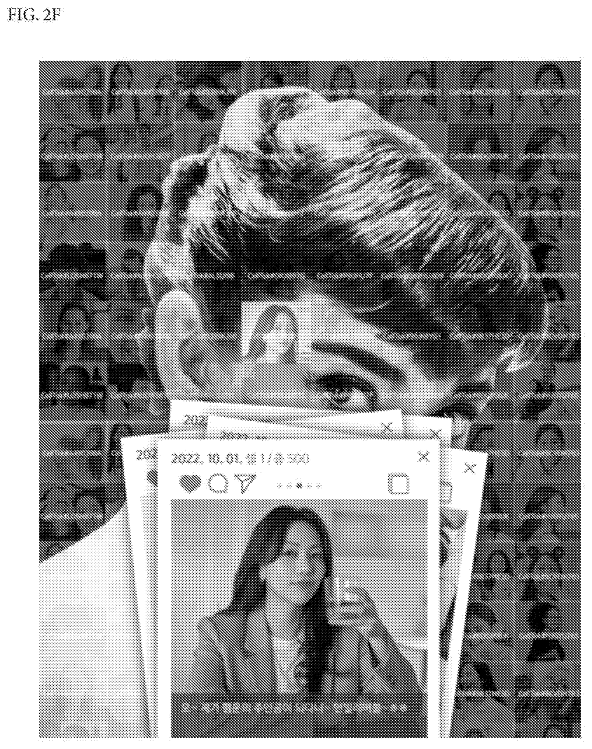

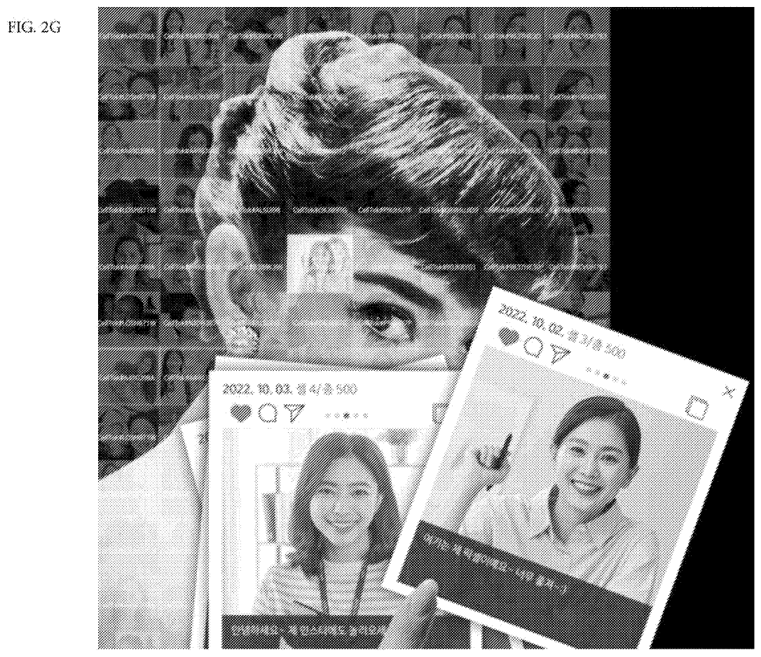

FIGS. 2A to 2G are images illustrating a state in which a primary creative work and secondary creative works cell-processed within the primary creative work are selected and displayed through the blockchain-based secondary creative work management system according to an embodiment of the present invention.

Hereinafter, a process of displaying secondary creative works from the primary creative work, and a process of exposing SNS information in conjunction with secondary creative works will be described with reference to FIGS. 2A to 2G.

First, a user may output a primary creative work as shown in FIG. 2A on a screen of the creator terminal 2 through an application installed therein. Then, the screen is converted into a cell display screen where secondary creative works are stored as shown in FIG. 2B, thus a screen displaying a plurality of cells such as a screen shown in FIG. 2C may be output.

The major factor of NFT traded through a smart contract-based multi-creative work management system according to an embodiment of the present invention is location values of the cells. The buyer who owns the location values may register the secondary creative works created by him or her and various meta information through the content platform implemented by the Cell NFT management server 10, and take advantage of the value of the primary creative work while distributing the secondary creative works and SNS addresses.

The user may click on the secondary creative work stored in any one cell as shown in FIG. 2C. When clicking, as shown in FIG. 2D, SNS information in conjunction with the secondary creative work may be displayed.

By repeating such processes, the user may repeatedly expose a plurality of SNS screens in conjunction with a plurality of secondary creative works, as shown in FIGS. 2E and 2F, and may read the SNS information as exposed in FIG. 2G by scrolling the same.

In other words, different types of data may be inserted according to the enlargement and reduction of an image of a star. In particular, if the user who inserts the secondary creative works into the cells is a fan of the star, there is a secondary effect capable of additionally obtaining significant cohesion and unity in addition to the investment in the creative works.

At this time, the primary creative work may be visible image data including a pictorial of a star, an image of star's daily life, a movie poster or movie scene data, or broadcast scene data or painting work, or acoustic data displayed as a digital waveform such that each section can be divided. But, the primary creative work is not limited to the data aimed only at the star.

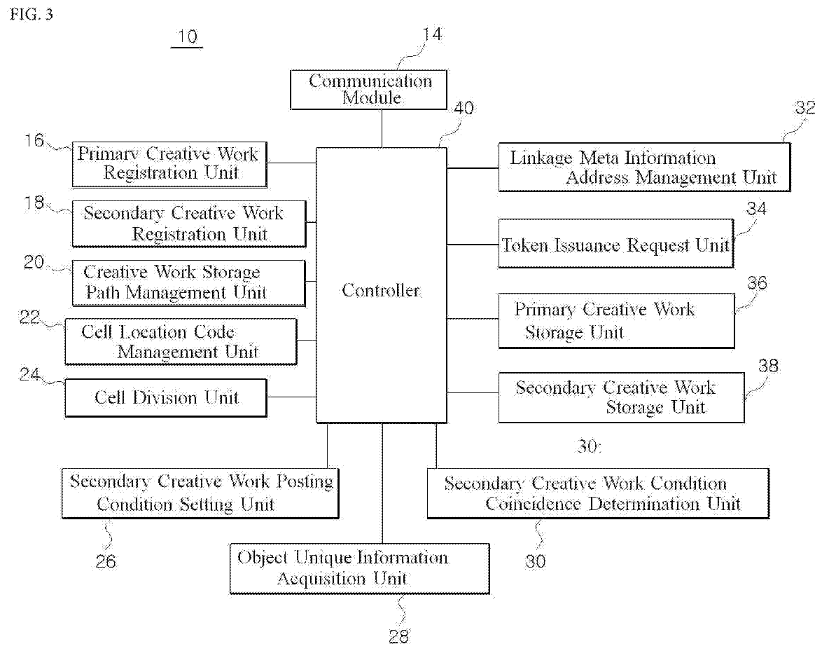

FIG. 3 is a block diagram illustrating the configuration of the cell NFT management server included in the blockchain-based secondary creative work management system according to an embodiment of the present invention.

Referring to FIG. 3, the cell NFT management server 10 included in the blockchain-based secondary creative work management system according to an embodiment of the present invention includes: a primary creative work registration unit 16 configured to register a primary creative work permitted by an original creator to display a secondary creative work of a secondary creator at a specific location on the primary creative work;
a cell division unit 24 configured to divide a display space on the primary creative work into a plurality of cells so that a plurality of secondary creative works can be displayed on the primary creative work registered in the primary creative work registration unit 16;
a secondary creative work registration unit 18 configured to map the secondary creative works of the secondary creator with locations of each cell of the primary creative work divided through the cell division unit 24 and register them, wherein the secondary creator has bought rights to display the secondary creative works at the locations; and a token issuance request unit 34 configured to request a generation of a non-fungible token (NFT) consisting of data related to the primary creative work and the cells, and an electronic wallet address on the blockchain using a smart contract.

The primary creator who registers the primary creative work generates a primary creative work in a virtual space, and allows the secondary creators to perform secondary creations such as inserting the secondary creative works newly created by them into any one cell obtained by spatially dividing the virtual primary creative work into the plurality of cells and displaying the same. Accordingly, when operating the system of the present invention, transactions for secondary creation spaces, that is, cells, resulting calculation and blockchain-based verification may be performed.

Meanwhile, the cell NFT management server 10 included in the blockchain-based secondary creative work management system according to an embodiment of the present invention further includes: a primary creative work storage unit 36 configured to store an original file (1_O_F) of the primary creative work permitted by an original creator to display the secondary creative work of the secondary creator at a specific location on the primary creative work; and a secondary creative work storage unit 38 configured to map an original file (2_O_F) of the secondary creative work registered through the secondary creative work registration unit 18 with a location of a cell divided and transferred by the secondary creator and store the same.

In this case, information recorded in the blocks through the smart contract includes at least an address code indicating a storage path of the primary creative work, address codes corresponding to the locations occupied by each cell in the primary creative work, and transaction history information.

In addition, the displaying of creative works implemented by a mobile app through the blockchain-based secondary creative work management system according to an embodiment of the present invention, and the displaying of mapped linkage information are implemented as shown in FIGS. 2A to 2G. However, a very important value through the non-fungible token (NFT) is the location values of the cells, and as a result, the present invention issues an independent non-fungible token (NFT) for each cell.

Meanwhile, the cell NFT management server 10 further includes an object unique information acquisition unit 28 configured to automatically acquire and manage unique information on the object of the creative work to be registered by the original creator in the primary creative work registration unit 16. In the blockchain-based secondary creative work management system, the object unique information may be included in the information recorded in the blocks through the smart contract.

At this time, when the object is a photograph, the object unique information may be a unique code generated by reflecting color of the photograph, direction of contrast (direction of light), a resolution of the photograph, and shape recognition information (digital conversion value) in the photograph, and it is configured so that the generated unique code is stored in the database by matching it with the object.

In addition, through the present invention, it is possible to issue blockchain-based NFTs consisting of the unique codes, and when a verification request signal for the object is received later, NFT verification may be performed through the blockchain verification technique and the object unique information.

Users may freely register the original file (2_O_F) of the secondary creative work prepared by them to be mapped with the location values of the cells owned by them, and register metadata such as an SNS access path.

To this end, the cell NFT management server 10 further includes a linkage meta information address management unit 32 configured to: receive a registration request signal for meta information in conjunction with the secondary creative work from the buyer terminal; register the linkage meta information; and manage the address.

In addition, the cell NFT management server 10 further includes: a secondary creative work posting condition setting unit 26 configured to set a posting condition guide of the secondary creative works for the primary creative work permitted by the primary creator to the secondary creator; and a secondary creative work condition coincidence determination unit 30 configured to automatically determine whether the creative work of the secondary creator coincides with information on the posting condition guide.

At this time, when the object is a photograph for example, the secondary creative work guide information may be information that limits the resolution, contrast, or color of the photograph that can be inserted into the cells reflecting location information. When the secondary creator inserts his or her own photograph into a bought cell, it is possible to recognize whether the photograph is the corresponding photograph based on the secondary creative work guide information.

On the other hand, conditions for the primary creator may be separately set, which is a configuration that allows the primary creator to set his or her own conditions, unlike limiting the posting conditions systematically or by the color or contrast ratio.

Meanwhile, the cell NFT management server 10 further includes a cell location code management unit 22 configured to manage the location information of the cells included for each non-fungible token (NFT). The cell location code management unit 22 separately manages the location occupied by each cell on the primary creative work along with the NFT code, and manages it in conjunction with the secondary creative work and meta information.

In addition, the cell NFT management server 10 further includes a creative work storage path management unit 20 configured to manage storage path information of the primary creative work and secondary creative work. If a size of the data exceeds a predetermined standard size, the primary creative work and secondary creative work are stored outside the blockchain network, that is, in the cell NFT management server 10, which is an external storage unit, without being packaged as NFT. Therefore, the storage path for the creative works should be managed separately.

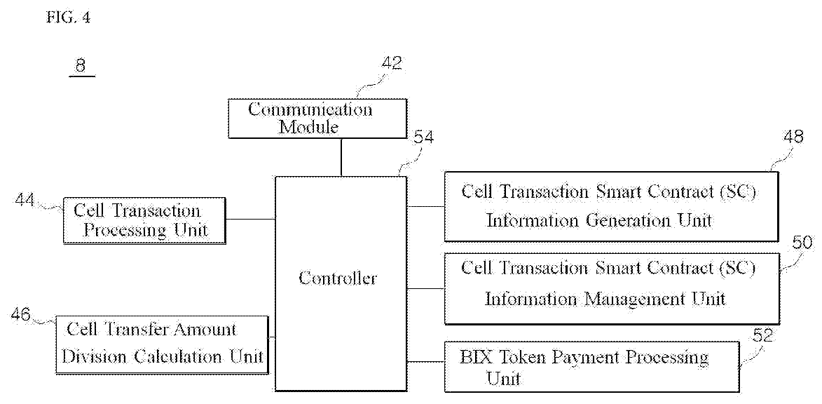

FIG. 4 is a block diagram illustrating the configuration of the NFT transaction processing server included in the blockchain-based secondary creative work management system according to an embodiment of the present invention.

Referring to FIG. 4, the NFT transaction processing server 8 included in the blockchain-based secondary creative work management system according to an embodiment of the present invention includes: a cell transaction processing unit 44 which processes to trade the cells divided into the plurality of cells so that each of the plurality of secondary creative works can be displayed on the primary creative work in conjunction with the cell NFT management server 10; and a cell transfer amount division calculation unit 46 configured to calculate and distribute a transfer amount generated through a transaction of any one cell between the primary creator of the primary creative work to which the cell belongs and owners of other cells excluding the owner of the cell that belongs to the primary creative work and the transaction has been made as a benefit amount.

In addition, the NFT transaction processing server 8 includes: a cell transaction smart contract information generation unit 48 configured to generate a code to record ownership change information changed due to a transfer of the cell as a code to be recorded in the blockchain; and a cell transaction smart contract information management unit 50 configured to manage information generated through the cell transaction smart contract information generation unit 48.

At this time, the cell transaction processing unit 44 serves to transfer a right to display the secondary creative works in a region of the cells formed by dividing the display space of any one primary creative work into a plurality of secondary creators. Precisely, this refers to a space divided from data limited to the virtually distributed creative works.

For example, when the photograph of a star is the primary creative work, the star becomes the primary creator. At this time, the right transferred to the secondary creator is the right to display the secondary creative works made up of fans'photographs in duplicate at specific locations of the primary creative work such as a photograph of the star.

The photograph of the star is divided into spaces like a mosaic, and the secondary creative works may be inserted into each divided cell. Fans of the star may buy a secondary creative space in the photograph of the star and insert their own photographs therein to create a mosaic-like work. Therefore, the fans of the star will be active buyers for the cells.

In addition, through the above-described process, the secondary creative works inserted by a plurality of users into the plurality of cells are ultimately created as completely new secondary creative works through activities like the collaborative work, which have greater value than the primary creative work such as the photograph of the star simply held by the fans.

In particular, if one of the star's best friends or the star's lover buys a cell in the star's creative work, and inserts a secondary creative work therein, its value may be further increased.

At this time, the cell transaction processing unit 44 processes to: register a minimum bid amount in consideration of an amount of the creative work set by the original copyright holder; register a minimum bid amount per unit of each secondary creative space to be divided and transferred to perform bid reception form the user; and perform successful bid processing for the secondary creative space for each location in an order of the highest bid amount.

Meanwhile, the NFT transaction processing server 8 further includes: a secondary creative work posting condition management unit (now shown) configured to register and manage creator's posting conditions for the secondary creative works; and a BIX token payment processing unit 52 configured to perform payment processing of a Blue IndeX (BIX) token, such as payment for verification of the primary creative work and verification of cell's ownership information, or payment for takeover of the cells.

Meanwhile, the cell transaction processing unit 44 processes to: register a minimum bid amount in consideration of an amount of the creative work set by the primary creator; register the number of cells to be divided and transferred and a minimum bid amount per unit thereof to perform bid reception from users; and perform successful bid processing for each cell in an order of the highest bid amount.

In addition, the cell transfer amount division calculation unit 46 processes to calculate so that a calculation ratio for the primary creator, which is preset for a transfer amount of any one cell, and a calculation ratio for owners who own other cells excluding the transferor who transfers the cell, are proportional to an initial bid amount.

At this time, it is processed so that a secondary creator who bought the cell at a high price receives a higher amount of calculation (e.g., the same concept as a dividend) than other secondary creators who bought the cell at a low price during transactions of other cells.

In addition, it is clear that the successful bid amounts for a plurality of secondary creative spaces will be different depending on their locations. Further, the system of the present invention includes a controller 54 configured to control the signal flow of each component unit through a communication module 42 for performing wired or wireless communication.

Next, functions and operations of the blockchain-based secondary creative work management system and method according to an embodiment of the present invention having the above-described configuration will be described in detail with reference to the accompanying drawings.

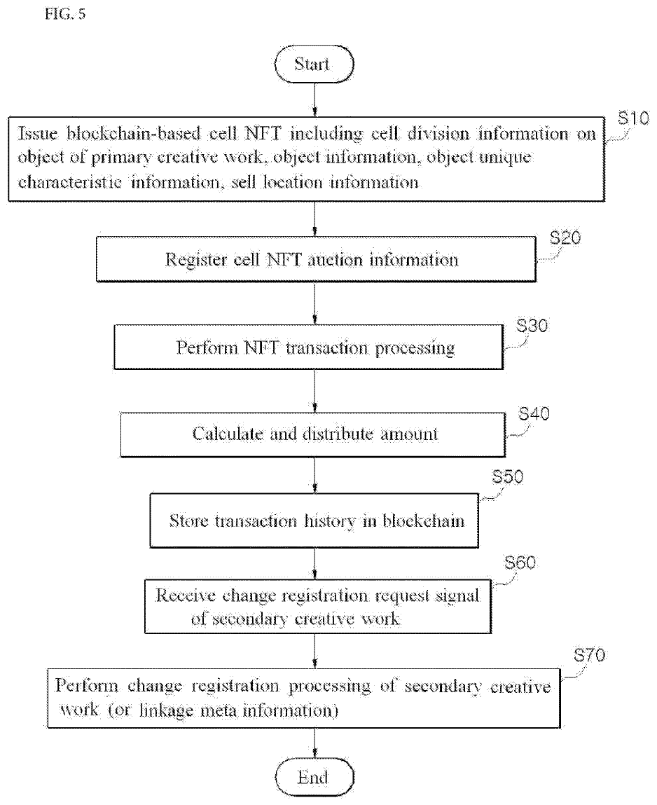

FIG. 5 is a flowchart illustrating procedures related to permission and registration processing for the secondary creative works through the blockchain-based secondary creative work management system according to an embodiment of the present invention.

First, through the blockchain-based secondary creative work management system according to an embodiment of the present invention, the cell NFT management server 10 receives token issuance request information including original data of the primary creative work and the number of cells generated by dividing the original data from the creator terminal 2 of the primary creator.

At this time, the determination on the original data of the primary creative work and the number of cells generated by dividing the original data is carried out by the primary creator, but the primary creator may delegate the authority to the cell NFT management server 10.

When the primary creative work file is received, the cell NFT management server 10 analyzes the original data (1_O_F) of the primary creative work, and registers object information and object unique characteristic information.

In this case, the cell NFT management server 10 may include, as parameters to be included in the NFT, the storage path address of the primary creative work and the location codes on the primary creative work of the cells formed by dividing the primary creative work, in which the secondary creative works are stored.

In addition, when registering the primary creative work, the primary creator may set conditions for the minimum profit generated through the sale of cells formed by dividing the primary creative work, and register limiting conditions on the data that can be inserted into the cells by setting.

When the primary creative work is registered, the cell NFT management server 10 divides the registered primary creative work into a plurality of cells, and transmits the NFT-containing data to the NFT transaction processing server 8 to issue NFTs.

Then, the NFT transaction processing server 8 registers auction information on the plurality of divided cells. In this case, auction processing is performed in a way that the bid amounts and the successful bid amounts are different depending on the location of the cells on the primary creative work for the plurality of cells formed by spatially dividing the primary creative work into a grid frame.

At this time, when dividing the primary creative work into the grid frame, the number of bidders and the bid amount vary depending on the location of each cell, such that the successful bid amount also varies depending on the location of each cell.

When the auction processing is performed for each cell in the NFT transaction processing server 8, a change in the owner of each cell also occurs. This also issues a smart contract that constitutes new original data reflecting the varied information by requesting the computing device 12 on the blockchain network 100.

A user who buys the cells as described above may insert the secondary creative work created or own by him or her into the cells to be displayed. As a result, the cell NFT management server 10 may receive the creative work of the secondary creator and register it in the divided cells.

Meanwhile, when a third user wishes to perform verification of the above-described registration step or registered information, he or she may request to perform blockchain verification for the primary creative work and blockchain verification for the cells. By paying a predetermined amount of coins by the NFT transaction processing server 8, information registration or verification may be performed.

In addition, if the current status of the secondary creative work does not coincide with the conditions registered by the primary creator, the cell NFT management server 10 processes so as not to register the secondary creative work in the cell.

In addition, the NFT transaction processing server 8 may perform division payment processing according to the calculation ratio for the primary creator, which is preset for a transfer amount of any one cell, and the calculation ratio for owners who own other cells excluding the transferor who transfers the cell.

Preferably, the division payment processing according to the calculation ratio for owners who own other cells in the same primary creative work excluding the transferor who transfers the cell may be additionally calculated in proportion to an initial bid amount. In other words, the secondary creator who buys the cell at a high price may receive a higher amount of calculation (e.g., the same concept as the dividend) than other secondary creators who buy the cell at a low price.

Meanwhile, the blockchain-based secondary creative work management system and method according to the embodiment of the present invention are not limited to the above-described embodiments, but may be variously modified without departing from the technical gist of the present invention.

### DESCRIPTION OF REFERENCE NUMERALS

2: Creator terminal
4: Seller terminal
6: Buyer terminal
8: NFT transaction processing server
10: Cell NFT management server
12: Computing device
100: Blockchain network.

1. A blockchain-based secondary creative work management system, the system comprising a cell NFT management server 10 which comprises:
a primary creative work registration unit 16 configured to register a primary creative work permitted by an original creator to display a secondary creative work of a secondary creator at a specific location on the primary creative work;
a cell division unit 24 configured to divide a display space on the primary creative work into a plurality of cells so that a plurality of secondary creative works are displayed on the primary creative work registered in the primary creative work registration unit 16;
a secondary creative work registration unit 18 configured to map the secondary creative works of the secondary creator with locations of each cell of the primary creative work divided through the cell division unit 24 and register them, wherein the secondary creator has bought rights to display the secondary creative works at the locations; and
a token issuance request unit 34 configured to request a generation of a non-fungible token (NFT) consisting of data related to the primary creative work and the cells, and an electronic wallet address on the blockchain using a smart contract.

2. The system according to claim 1, wherein the cell NFT management server 10 further comprises: a primary creative work storage unit 36 configured to store an original file (1_O_F) of the primary creative work permitted by an original creator to display the secondary creative work of the secondary creator at a specific location on the primary creative work; and
a secondary creative work storage unit 38 configured to map an original file (2_O_F) of the secondary creative work registered through the secondary creative work registration unit 18 with a location of a cell divided and transferred by the secondary creator and store the same.

3. The system according to claim 1, wherein information recorded in blocks through the smart contract comprises at least an address code indicating a storage path of the primary creative work, address codes corresponding to the locations occupied by each cell in the primary creative work, and transaction history information.

4. The system according to claim 1, wherein the cell NFT management server 10 further comprises an object unique information acquisition unit 28 configured to automatically acquire and manage unique information on the object of the creative work to be registered by the original creator in the primary creative work registration unit 16, wherein the object unique information is included in information recorded in the blocks through the smart contract.

5. The system according to claim 1, wherein the cell NFT management server 10 further comprises a linkage meta information address management unit 32 configured to: receive a registration request signal for meta information in conjunction with the secondary creative work from a buyer terminal; register the linkage meta information; and manage the address.

6. The system according to claim 1, wherein the cell NFT management server 10 further comprises: a secondary creative work posting condition setting unit 26 configured to set a posting condition guide of the secondary creative works for the primary creative work permitted by the primary creator to the secondary creator; and
a secondary creative work condition coincidence determination unit 30 configured to automatically determine whether the creative work of the secondary creator coincides with information on the posting condition guide.

7. The system according to claim 1, wherein the cell NFT management server 10 further comprises a cell location code management unit 22 configured to manage location information of the cells included for each non-fungible token (NFT).

8. The system according to claim 1, wherein the cell NFT management server 10 further comprises a creative work storage path management unit 20 configured to manage storage path information of the primary creative work and secondary creative work.

9. The system according to claim 1, further comprising an NFT transaction processing server 8 which comprises:
a cell transaction processing unit 44 which processes to trade the cells divided into the plurality of cells so that each of the plurality of secondary creative works is displayed on the primary creative work, in conjunction with the cell NFT management server 10;
a cell transfer amount division calculation unit 46 configured to calculate and distribute a transfer amount generated through a transaction of any one cell between the primary creator of the primary creative work to which the cell belongs and owners of other cells excluding the owner of the cell that belongs to the primary creative work and the transaction has been made as a benefit amount;
a cell transaction smart contract information generation unit 48 configured to generate a code to record ownership change information changed due to a transfer of the cell as a code to be recorded in the blockchain; and
a cell transaction smart contract information management unit 50 configured to manage information generated through the cell transaction smart contract information generation unit 48.

10. The system according to claim 9, wherein the NFT transaction processing server 8 further comprises: a secondary creative work posting condition management unit configured to register and manage creator's posting conditions for the secondary creative works; and
a BIX token payment processing unit 52 configured to perform payment processing of a Blue IndeX (BIX) token, such as payment for verification of the primary creative work and verification of cell's ownership information, or payment for takeover of the cells.

11. The system according to claim 1, wherein the primary creative work is visible image data including a pictorial of a star, an image of star's daily life, a movie poster or movie scene data, or broadcast scene data or painting work, or acoustic data displayed as a digital waveform such that each section can be divided.

12. The system according to claim 1, wherein the cells are distinguished by dividing a size of a single primary creative work into a grid frame having a predetermined number of rows and columns.

13. The system according to claim 9, wherein the cell transaction processing unit 44 processes to: register a minimum bid amount in consideration of an amount of the creative work set by the primary creator; register the number of cells to be divided and transferred and a minimum bid amount per unit thereof to perform bid reception from users; and perform successful bid processing for each cell in an order of the highest bid amount.

14. The system according to claim 9, wherein the cell transfer amount division calculation unit 46 processes to calculate so that a calculation ratio for an original creator, which is preset for a transfer amount of any one cell, and a calculation ratio for owners who own other cells excluding a transferor who transfers the cell, are proportional to an initial bid amount.

15. A blockchain-based secondary creative work management method, the method comprising:
a) receiving, by a cell NFT management server 10, token issuance request information including original data of a primary creative work and the number of cells generated by dividing the original data from a creator terminal 2 of a primary creator;
b) dividing, by the cell NFT management server 10, the registered primary creative work into a plurality of cells;
c) performing, by an NFT transaction processing server 8, auction processing on the plurality of divided cells;
d) receiving and registering, by the cell NFT management server 10, a creative work of a secondary creator in the divided cell;
e) processing, by the NFT transaction processing server 8, issuing of an NFT including creative work-related information which includes a storage path address of the primary creative work and location addresses of the cells, and processing to record the creative work-related information in blocks based on the blockchain.

16. The method according to claim 15, wherein the step c) comprises performing auction processing in a way that minimum bid amounts are different depending on the locations of the cells formed by spatially dividing the primary creative work into a grid frame.

17. The method according to claim 15, in any one of the steps c) and d), when receiving a request to perform blockchain verification for the primary creative work and blockchain verification for the cells, paying a predetermined amount of coins to the blockchain system, by the NFT transaction processing server 8.

18. The method according to claim 15, in the step d), if conditions of the secondary creative work do not coincide with conditions registered by the primary creator, processing so as not to register the secondary creative work in the cell bough by the secondary creator, by the cell NFT management server 10.

19. The method according to claim 15, in the step e), further comprising adding owner information of the cell, object information of the creative work, and transaction history information on the cell to the NFT to be included therein.

20. The method according to claim 15, wherein after the step e),
further comprising performing, by the NFT transaction processing server 8, division payment processing according to a calculation ratio for the primary creator, which is preset for a transfer amount of any one cell, and a calculation ratio for owners who own other cells excluding a transferor who transfers the cell.

21. The method according to claim 20, wherein, in the processing step for calculation, the division payment processing according to the calculation ratio for owners who own other cells in the same primary creative work excluding the transferor who transfers the cell further comprises performing calculation processing in proportion to an initial bid amount.

22. The method according to claim 15, wherein the step d) further comprises receiving, by the cell NFT management server 10, a registration request signal for meta information in conjunction with the secondary creative work from the creator terminal 2 of the secondary creator, and mapping the received registration request signal.
